(19) United States
(12) Patent Application Publication
(10) Pub. No.: US 2019/0373842 A1
(43) Pub. Date: Dec. 12, 2019

(54) CONTROL DEVICE, ANIMAL TOILET, AND METHOD OF CONTROLLING ANIMAL TOILET

(71) Applicant: SHARP KABUSHIKI KAISHA, Osaka (JP)

(72) Inventor: SHIGEFUMI URATA, Osaka (JP)

(21) Appl. No.: 16/424,908

(22) Filed: May 29, 2019

(30) Foreign Application Priority Data
Jun. 8, 2018 (JP) 2018-110674

(51) Int. Cl. A01K 1/01; A01K 1/015; A01K 29/00; G01G 19/52; G01G 23/36

(52) U.S. Cl. CPC A01K 1/011; A01K 1/0157; G01G 23/36; G01G 19/52; A01K 29/005

(57) ABSTRACT

Provided is a control device which controls an animal toilet. The control device includes: a weight obtaining section which obtains a weight of an excreta tray; a disposition state determining section which determines whether or not the excreta tray is disposed; and a disposition state notifying section which causes a notification to be sent to a user.

This Nonprovisional application claims priority under 35 U.S.C. § 119 on Patent Application No. 2018-110674 filed in Japan on Jun. 8, 2018, the entire contents of which are hereby incorporated by reference.

### TECHNICAL FIELD

The present invention relates to a control device, an animal toilet, and a method of controlling an animal toilet.

### BACKGROUND

Patent Literature 1 discloses an animal toilet including (i) a first weight scale which measures a weight of an excreta tray and (ii) a second weight scale which measures a weight of a measurement stage for an animal. According to such an animal toilet, it is possible to accurately measure a weight of an animal without being affected by a weight of excreta.

### CITATION LIST

### Patent Literature

[Patent Literature 1] PCT International Publication No. WO2017/104216

### SUMMARY OF INVENTION

### Technical Problem

However, according to the foregoing conventional technique, it is difficult to see, from the outside, a state where the excreta tray is disposed in the animal toilet. Accordingly, there is a problem that, in a case where a user forgets to place the excreta tray in the animal toilet, the user does not easily notice such a fact. In order to confirm that the excreta tray is disposed in the animal toilet, the user needs to visually check the excreta tray by, for example, drawing out the excreta tray on a regular basis.

An object of an aspect of the present invention is to provide a control device, an animal toilet, and a method of controlling an animal toilet, each of which allows a user to grasp a disposition state of an excreta tray without making a visual check.

### Solution to Problem

In order to attain the above object, a control device in accordance with an aspect of the present invention is a control device which controls an animal toilet, the control device including: a weight obtaining section which obtains, over time, a weight of a holding section that is configured to hold excreta of an animal and is configured to be disposed in the animal toilet so as to be located under a place onto which the animal steps; a disposition state determining section which determines that the holding section is not disposed in the animal toilet, in a case where the weight obtaining section has not obtained a weight corresponding to the holding section for a given time; and a disposition state notifying section which causes a notification to be sent to a user, in a case where the disposition state determining section determines that the holding section is not disposed in the animal toilet.

A method of controlling an animal toilet in accordance with an aspect of the present invention is a method of controlling an animal toilet, the method including: a weight obtaining step of obtaining, over time, a weight of a holding section that is configured to hold excreta of an animal and is configured to be disposed in the animal toilet so as to be located under a place onto which the animal steps; a disposition state determining step of determining that the holding section is not disposed in the animal toilet, in a case where a weight corresponding to the holding section has not been obtained for a given time in the weight obtaining step; and a disposition state notifying step of causing a notification to be sent to a user, in a case where it is determined, in the disposition state determining step, that the holding section is not disposed in the animal toilet.

### Advantageous Effects of Invention

According to an aspect of the present invention, it is possible to provide a control device, an animal toilet, and a method of controlling an animal toilet, each of which allows a user to grasp a disposition state of an excreta tray without making a visual check.

### BRIEF DESCRIPTION OF DRAWINGS

FIG. 1 is a block diagram illustrating a configuration of an animal toilet in accordance with Embodiment 1 of the present invention.

FIG. 2 is a block diagram illustrating a configuration of an animal toilet and a configuration of a server in accordance with a variation of Embodiment 1 of the present invention.

FIG. 3 is a flowchart illustrating a flow of a process which is carried out by a control section included in the animal toilet in accordance with Embodiment 1 of the present invention.

(a) of FIG. 4 is a view illustrating the configuration of the animal toilet in accordance with Embodiment 1 of the present invention. (b) of FIG. 4 is an exploded view illustrating a state where the animal toilet is disassembled.

FIG. 5 is a cross-sectional view illustrating a cross-sectional configuration of the animal toilet illustrated in FIG. 4.

FIG. 6 is a flowchart illustrating a flow of a process which is carried out by a control section included in an animal toilet in accordance with Embodiment 2 of the present invention.

FIG. 7 is a view illustrating a change in value measured by a weight scale included in the animal toilet in accordance with Embodiment 2 of the present invention. (a) of FIG. 7 is a view illustrating a state where an excreta tray is disposed properly. (b) of FIG. 7 is a view illustrating a state where a user forgets to dispose the excreta tray. (c) of FIG. 7 is a view illustrating a state where the user forgets to dispose a urine sheet.

FIG. 8 is a cross-sectional view illustrating a cross-sectional configuration of an animal toilet in accordance with Embodiment 3 of the present invention.

FIG. 9 is a view illustrating a change in value measured by a weight scale included in the animal toilet illustrated in FIG. 8.

### DESCRIPTION OF EMBODIMENTS

### Embodiment 1

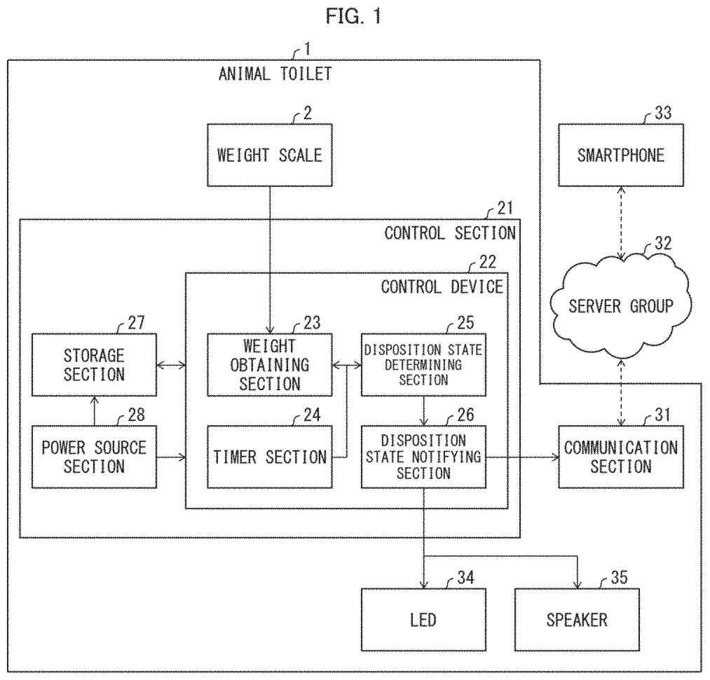

The following description will discuss Embodiment 1 of the present invention with reference to FIGS. 1 through 5.

(Configuration of Animal Toilet)

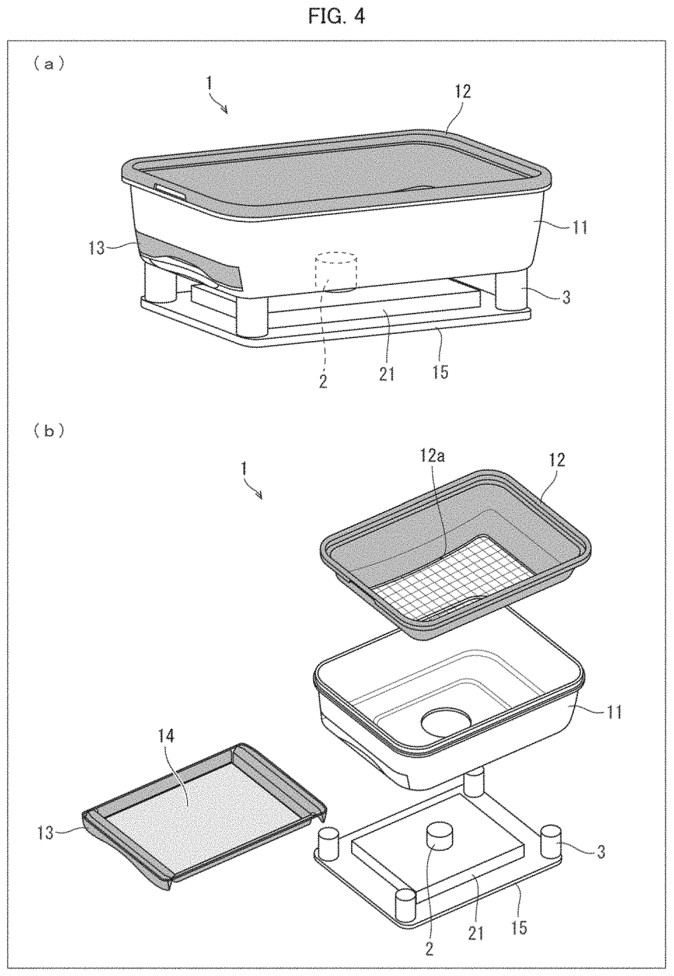

As illustrated in (a) and (b) of FIG. 4 and FIG. 5, an animal toilet 1 in accordance with Embodiment 1 includes a weight scale 2, body weight scales 3, a container body 11, an excretion stage 12 (a place onto which an animal steps), an excreta tray 13 (holding section), a supporting section 15, and a control section 21. (a) of FIG. 4 is a view illustrating a configuration of the animal toilet 1 in accordance with Embodiment 1 of the present invention. (b) of FIG. 4 is an exploded view illustrating a state where the animal toilet 1 illustrated in (a) of FIG. 4 is disassembled. FIG. 5 is a cross-sectional view illustrating a cross-sectional configuration of the animal toilet 1 illustrated in FIG. 4.

The weight scale 2 measures a weight of the excreta tray 13 over time. A value measured by the weight scale 2 is obtained by the control section 21. A weight of the container body 11 and the excretion stage 12 is independent from the weight of the excreta tray 13, and is measured by the body weight scales 3. According to such a configuration that the weight scale 2 and the body weight scales 3 are independently provided, the weight scale 2 is not affected by the weight of the container body 11 and the excretion stage 12, the weight of the container body 11 and the excretion stage 12 greatly varying by the animal stepping onto or stepping down from the excretion stage 12. This allows the weight scale 2 to accurately measure merely the weight of the excreta tray 13. Furthermore, this allows the body weight scales 3 to accurately measure merely a body weight of the animal, regardless of whether or not urine and/or the like (excreta) is/are present on the excreta tray 13.

The weight measured by the weight scale 2 is lighter than that measured by the body weight scales 3. Therefore, a maximum measurable load of the weight scale 2 can be lower than that of the body weight scales 3. For this reason, the weight scale 2 can be made simpler in structure and can be made smaller in size than the body weight scales 3. Furthermore, the weight scale 2 can be made more accurate in measurement than the body weight scales 3. By thus independently providing the weight scale 2 and the body weight scales 3, each of which is suitable for its use application, it is possible to provide the animal toilet 1 which is inexpensive and is highly accurate in measurement.

The container body 11 supports the excretion stage 12. The container body 11 and the excretion stage 12 preferably come in a plurality of sizes, depending on the animal which uses the animal toilet 1. The excretion stage 12 is a stage onto which the animal steps and on which the animal excretes. The excretion stage 12 includes a mesh part 12a in the form of a mesh so that urine drops on the excreta tray 13 disposed under the excretion stage 12.

The mesh part 12a allows a liquid to pass therethrough, but does not allow, for example, feces and an object (toy), which has been brought by the animal, to pass therethrough. The mesh part 12a can be formed from a liquid permeable cloth, a liquid permeable thin film, or the like. The excretion stage 12 can alternatively have a hole(s) through which excreta pass, instead of the mesh part 12a. According to Embodiment 1, the excretion stage 12 is a container having a depressed shape. However, the excretion stage 12 can have any shape, provided that the excretion stage 12 allows the animal to step onto the excretion stage 12.

The excreta tray 13 is a member which is disposed under the excretion stage 12 and on which excreta are held. A size of the excreta tray 13 is preferably larger than that of a region, in which the mesh part 12a is formed, of the excretion stage 12, as viewed from the container body toward the supporting section 15. A urine sheet 14 (excreta absorbing sheet) can be disposed on the excreta tray 13. The urine sheet 14 is a sheet which absorbs a liquid such as urine. The excreta tray 13 is removably housed in the animal toilet 1.

Note that the excreta tray 13 can be configured such that a tray part, on which excreta are held, and a frame part, in which the tray part is housed, are separated from each other. In this case, there can be a state where merely the frame part is disposed in the animal toilet 1 without the tray part being housed in the frame part. This causes an increased need to detect that the tray part is not housed in the frame part.

The supporting section 15 is a base plate which supports the weight scale 2 and the body weight scales 3. According to Embodiment 1, the control section 21 is disposed on the supporting section 15, and the weight scale 2 is disposed on the control section 21. In this manner, the supporting section 15 can indirectly support the weight scale 2 and/or the body weight scales 3 via the control section 21 and the like. Note that the control section 21 is not necessary to be disposed under the weight scale 2, and can be disposed at any location in the animal toilet 1.

(Configuration of Control Section)

As illustrated in FIG. 1, the animal toilet 1 further includes a communication section 31, an LED (Light Emitting Diode) 34, and a speaker 35. The control section 21 includes a control device 22, a storage section 27, and a power source section 28. FIG. 1 is a block diagram illustrating the configuration of the animal toilet 1 in accordance with Embodiment 1 of the present invention. The animal toilet 1 includes the control device 22 in order to notify a user of a disposition state of the excreta tray 13.

The control device 22 includes a weight obtaining section 23, a timer section 24, a disposition state determining section 25, and a disposition state notifying section 26. According to Embodiment 1, the control section is embedded in the animal toilet 1, and the control device 22 controls operation of the animal toilet 1. The control section 21 detects a state of the excreta tray 13 via the weight scale 2 included in the animal toilet 1, and outputs a notification signal for causing, depending on the state, a notification to be sent to the user.

(Flow of Process Carried Out by Control Section)

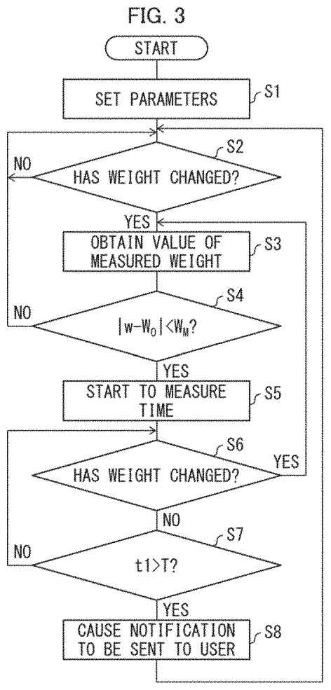

A flow of a process (method of controlling an animal toilet) which is carried out by the control section 21 will be described below with reference to FIG. 3. FIG. 3 is a flowchart illustrating a flow of a process which is carried out by the control section 21 included in the animal toilet 1 in accordance with Embodiment 1 of the present invention.

First, in a case where the animal toilet 1 is turned on, the power source section 28 is turned on. Information indicating that the power source section 28 is turned on is supplied to the control device 22, and is stored in the storage section 27. Subsequently, in the control section 21, an initial measured value W_{O} and a state confirmation waiting time T are set (S1).

The initial measured value W_{O} is a value of a weight measured by the weight scale 2 in a state where the excreta tray 13 is not disposed in the animal toilet 1. The initial measured value W_{O} can be preset before the animal toilet 1 is shipped from a factory. Alternatively, the user can set the initial measured value W_{O} before using the animal toilet 1. In a case where the user sets the initial measured value W_{O}, the initial measured value W_{O} is set by the user, for example, conducting a given operation in a state where the excreta tray 13 is not disposed in the animal toilet 1.

The state confirmation waiting time T indicates a time period from when the value of the weight measured by the weight scale 2 changed until when the control section 21 confirms such a change. The state confirmation waiting time T can be preset before the animal toilet 1 is shipped from the factory or can be set by the user. The initial measured value W_{O} and the state confirmation waiting time T thus set are stored in the storage section 27, and are obtained, as needed, by the control device 22, depending on the process described below.

(Configuration of Weight Obtaining Section)

The weight obtaining section 23 determines whether or not a weight “w” measured by the weight scale 2 has changed (S2). In a case where the weight “w” measured by the weight scale 2 has changed (YES in S2), the weight obtaining section 23 obtains, over time, a value of the weight “w” measured by the weight scale 2 (S3: weight obtaining step). In a case where the weight “w” measured by the weight scale 2 has not changed (NO in S2), the weight obtaining section 23 continues a process in S2. The weight obtaining section 23 can obtain, in real time, the value of the weight “w” measured by the weight scale 2.

Note that the weight obtaining section 23 can determine whether or not the weight “w” measured by the weight scale 2 has changed, depending on whether or not an amount of a change in weight “w” is equal to or greater than an acceptable value of error W_{M}. Note also that, in a case where the weight obtaining section 23 determines whether or not the weight “w” measured by the weight scale has changed, the weight obtaining section 23 can determine whether or not the weight “w” measured by the weight scale 2 has changed, depending on whether or not the amount of the change in weight “w” is equal to or greater than an acceptable value of error W_{N}, which is different from the acceptable value of error W_{M}.

The weight obtaining section 23 can obtain the value of the weight “w” at given time intervals, in accordance with time information inputted from the timer section 24 which operates in cooperation with the weight obtaining section 23. In FIG. 3, a process in S3, that is, a process in which the weight obtaining section 23 obtains the value of the weight “w” will be hereinafter omitted. The value of the weight “w” obtained by the weight obtaining section 23 is supplied to the disposition state determining section 25.

(Configuration of Disposition State Determining Section)

The disposition state determining section 25 receives the value of the weight “w” from the weight obtaining section 23. The disposition state determining section 25 first calculates a difference between (i) the weight “w” measured by the weight scale 2 and (ii) the initial measured value W_{O}, and compares an absolute value of the difference (|w−W_{O}|) with the acceptable value of error W_{M} (S4).

In a case where a value of |w−W_{O}| is lower than the acceptable value of error W_{M} (YES in S4), the disposition state determining section 25 determines that the excreta tray 13 is detached from the animal toilet 1. Then, the process carried out by the control section 21 next proceeds to S5. In a case where the value of |w−W_{O}| is equal to or higher than the acceptable value of error W_{M} (NO in S4), the disposition state determining section 25 determines that the excreta tray 13 is not detached from the animal toilet 1. Then, the process carried out by the control section 21 returns to S2.

Subsequently, the disposition state determining section 25 starts to measure elapsed time t1 in cooperation with the timer section 24 (S5). After the disposition state determining section 25 has started to measure the elapsed time t1, the weight obtaining section 23 determines whether or not the weight “w” measured by the weight scale 2 has changed (S6). In a case where the weight “w” measured by the weight scale 2 has changed by a given value or more of a weight of the excreta tray 13 (YES in S6), the disposition state determining section 25 confirms a determination that the excreta tray 13 is disposed in the animal toilet 1. In a case where the disposition state determining section 25 confirms such a determination, the process carried out by the control section 21 returns to S3.

Note that the following description discusses a case where the excreta tray 13 is merely disposed. Note, however, that, by reading the phrase “the excreta tray 13” as “the excreta tray 13 and the urine sheet 14”, it is understood that the animal toilet 1 similarly operates also in a case where the urine sheet 14 is disposed on the excreta tray 13.

On the other hand, in a case where the weight “w” measured by the weight scale 2 has not changed (NO in S6), the disposition state determining section 25 determines whether or not the elapsed time t1 has exceeded the state confirmation waiting time T (S7). In a case where the elapsed time t1 has exceeded the state confirmation waiting time T (YES in S7), the disposition state determining section 25 confirms a determination that the excreta tray 13 has not been disposed in the animal toilet 1 for a long time (time which exceeds the state confirmation waiting time T) (disposition state determining step). As such, in a case where the weight obtaining section 23 has not obtained, for a given time (elapsed time t1), a weight corresponding to the excreta tray 13, the disposition state determining section 25 determines that the excreta tray 13 has not been disposed in the animal toilet 1 for a long time. In a case where the disposition state determining section 25 confirms such a determination, the process carried out by the control section 21 next proceeds to S8.

A process in S7 is a process for excluding temporary detachment of the excreta tray 13 from detachment to be notified to the user. That is, in a case where (i) the disposition state of the excreta tray 13 has changed and (ii) such a change in disposition state of the excreta tray 13 indicates a temporary detachment for cleaning of the excreta tray 13 by the user, it is not necessary to notify the user.

By confirming the change in disposition state of the excreta tray 13 merely in a case where the elapsed time t1 has exceeded the state confirmation waiting time T after the disposition state of the excreta tray 13 changed, it is possible to send a notification to the user merely in a case where the notification is necessary, for example, in a case where the user forgets to dispose the excreta tray 13. It is assumed that the state confirmation waiting time T is, for example, approximately 5 minutes to 60 minutes. Note, however, that the state confirmation waiting time T is not limited to such time.

In a case where the disposition state determining section 25 confirms a determination that the excreta tray has not been disposed in the animal toilet 1, the disposition state determining section 25 supplies such a determination result to the disposition state notifying section 26. On the other hand, in a case where the elapsed time t1 is equal to or shorter than the state confirmation waiting time T (NO in S7), the process carried out by the control section 21 returns to S6.

(Disposition State Notifying Section)

In a case where the disposition state notifying section 26 receives the determination result indicating that the excreta tray 13 has not been disposed in the animal toilet 1 for a long time, the disposition state notifying section 26 outputs a notification signal for causing a notification to be sent to the user. The notification signal is inputted in, for example, the communication section 31 included in the animal toilet 1. The communication section 31 which has received the notification signal sends, via a server group 32, a notification to an information terminal, such as a smartphone 33, which the user possesses (S8: disposition state notifying step). The notification is a notification indicating that the excreta tray 13 has not been disposed in the animal toilet 1 for a long time. The server group 32 is a cloud server. Thus, in a case where the disposition state determining section 25 determines that the excreta tray 13 has not been disposed in the animal toilet 1 for a long time, the disposition state notifying section 26 causes the notification to be sent to the user.

Due to such a notification, it is possible for the user to grasp the disposition state of the excreta tray 13 by receiving the notification timely, in a case where the excreta tray 13 has not been disposed in the animal toilet 1 for a long time. This makes it unnecessary for the user to visually check the excreta tray 13 which is difficult to see from the outside. In this case, even in a case where the user does not stay near the animal toilet 1, for example, even in a case where the user is outside his/her house, it is possible for the user to receive the notification. The information terminal is not particularly limited to the smartphone 33, and can be alternatively a typical mobile phone, a tablet terminal, a PC (Personal Computer), or the like.

The animal toilet 1 can include a light emitting section, such as the LED 34, and/or a sound producing section, such as the speaker 35. In this case, the notification signal can be inputted, not in the communication section 31, but in the LED 34 and/or the speaker 35 included in the animal toilet 1. By receiving the notification in the form of a change in way in which the LED 34 emits light and/or in the form of an alarm produced by the speaker 35, it is possible for the user to grasp a fact that the excreta tray 13 has not been disposed in the animal toilet 1.

According to the above configuration, since the notification is sent from the animal toilet 1, it is possible for the user to immediately dispose the excreta tray 13. Note that the notification can be sent from merely one of (i) the animal toilet 1 and (ii) the smartphone 33 or the like via the server group 32 or can be alternatively simultaneously sent from both of them.

In a case where the notification is sent from the animal toilet 1, the notification can be sent to the animal so that the animal is notified of a fact that preparation of the animal toilet 1 has not been completed. Note that the notification is sent to the animal by, for example, the speaker 35 producing a sound having a frequency which the animal that uses the animal toilet 1 easily notices. However, a way in which the notification is sent to the animal is not limited to such a way, and various ways can be employed. The notification can be sent to the animal by, for example, the speaker 35 producing a sound having a frequency which the animal does not like, as the sound having a frequency which the animal easily notices. Preferably, the notification is continuously sent to the animal. According to the above configuration, it is possible to prevent the animal from excreting on the animal toilet 1, in a state where the preparation of the animal toilet 1 has not been completed, for example, in a state where the excreta tray 13 is not disposed in the animal toilet 1 or in a state where the urine sheet 14 is not disposed on the excreta tray 13.

(Variation)

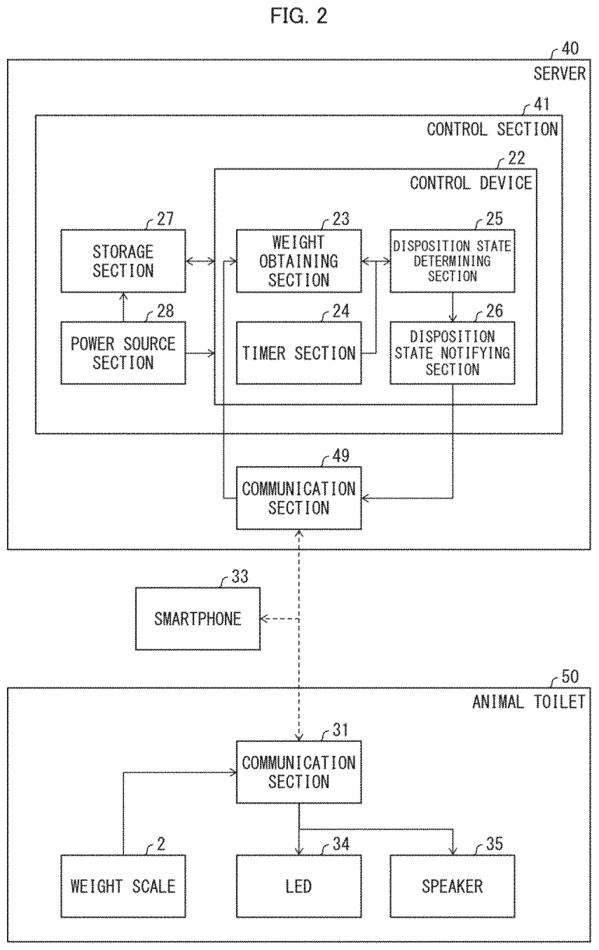

A variation of Embodiment 1 will be described below with reference to FIG. 2. FIG. 2 is a block diagram illustrating a configuration of an animal toilet 50 and a configuration of a server 40 in accordance with the variation of Embodiment 1 of the present invention. A control section 41 in accordance with the present variation is not embedded in the animal toilet 50 but is provided to the server 40. In this point, the control section 41 is different from the control section 21. The server 40 includes the control section 41 and a communication section 49. A configuration and a function of the control section 41 are similar to those of the control section 21.

In the animal toilet 50 in accordance with the present variation, a value measured by the weight scale 2 is transmitted to a weight obtaining section 23 of the server 40 via a communication section 31. The control section 41 of the server 40 determines a state of the animal toilet 50 in accordance with a measured value received via a telecommunication line such as the Internet. In a case where it is determined, in the control section 41, that an excreta tray 13 has not been disposed in the animal toilet 50, a disposition state notifying section 26 transmits a notification signal to a smartphone 33 of a user and/or the animal toilet 50 via the communication section 49 and the telecommunication line such as the Internet. In a case where the notification signal is transmitted to the animal toilet 50, the notification signal is inputted in, for example, an LED 34 and/or a speaker 35 included in the animal toilet 50, and a notification is sent to the user. According to the above configuration, it becomes unnecessary to provide the control section 41 to the animal toilet 50. This makes it possible to provide, at a low cost, the animal toilet 50 having a function that is realized by the control section 41 in accordance with the present variation.

### Embodiment 2

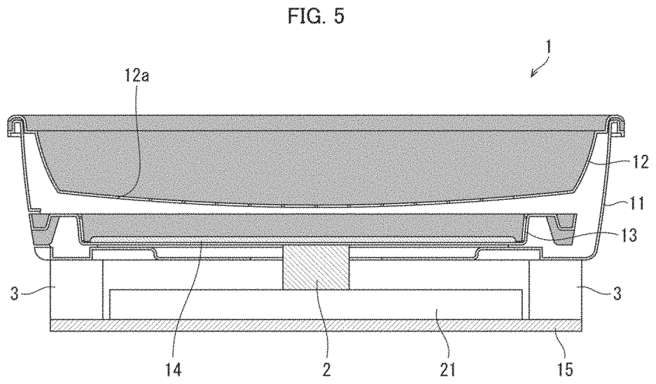

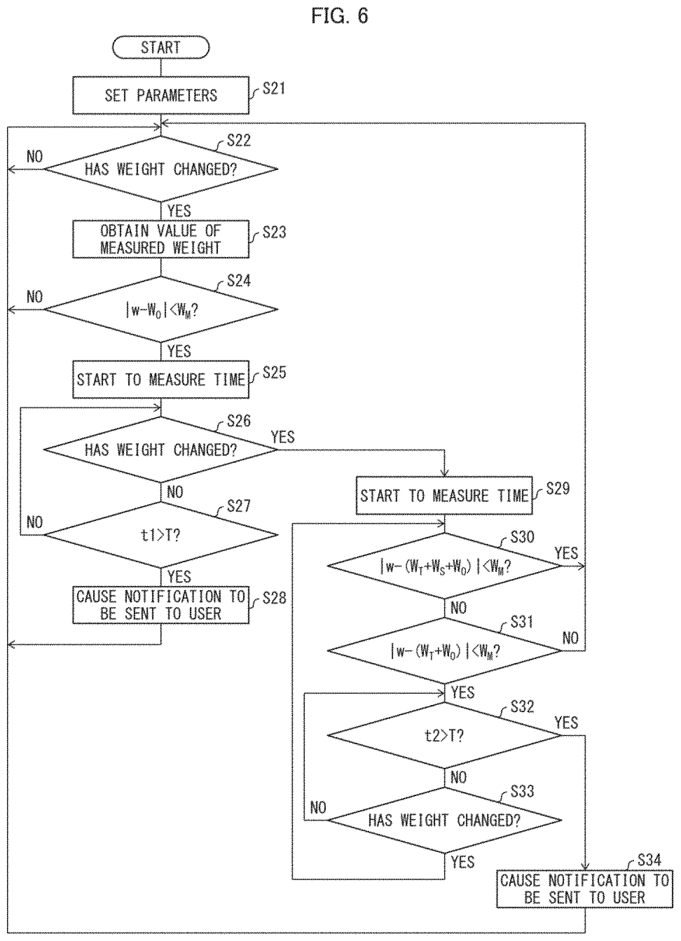

The following description will discuss Embodiment 2 of the present invention with reference to FIGS. 6 and 7. Note that, for convenience, a member having a function identical to that of a member described in Embodiment 1 will be given an identical reference numeral, and will not be described below.

FIG. 6 is a flowchart illustrating a flow of a process which is carried out by a control section 21 included in an animal toilet 1 in accordance with Embodiment 2 of the present invention. FIG. 7 is a view illustrating a change in value measured by a weight scale 2 included in the animal toilet 1 in accordance with Embodiment 2 of the present invention. (a) of FIG. 7 is a view illustrating a state where an excreta tray 13 is disposed properly. (b) of FIG. 7 is a view illustrating a state where a user forgets to dispose the excreta tray 13. (c) of FIG. 7 is a view illustrating a state where the user forgets to dispose a urine sheet 14.

The control section 21 in accordance with Embodiment 2 is different from the control section 21 in accordance with Embodiment 1 in that the control section in accordance with Embodiment 2 has a function of causing a notification to be sent to the user in a case where the urine sheet 14 (excreta absorbing sheet) has not been disposed on the excreta tray 13.

(Flow of Process)

As illustrated in FIG. 6, in the control section 21, a urine sheet weight W_{S} as well as an initial measured value Wo, an excreta tray weight W_{T}, and a state confirmation waiting time T are set (S21). According to Embodiment 2, the excreta tray weight W_{T} can be preset in accordance with a weight of the excreta tray 13 before the animal toilet 1 is shipped from a factory or can be alternatively set by the user, as well as the initial measured value W_{O}.

The urine sheet weight W_{S} can be preset in accordance with a weight of a commercially available urine sheet before the animal toilet 1 is shipped from the factory or can be alternatively set by the user. In a case where the urine sheet weight W_{S} is preset before the animal toilet 1 is shipped from the factory, one or more kinds of recommended urine sheet products can be designated. This makes it possible to set an accurate urine sheet weight W_{S} corresponding to a urine sheet product.

In a case where the user sets the urine sheet weight W_{S}, the user can freely select a favorite urine sheet product and set an accurate urine sheet weight W_{S} corresponding to the favorite urine sheet product thus selected. Alternatively, purchase history of urine sheet products which the user has bought can be stored in a server group 32. In this case, the control section 21 can refer to the purchase history via a communication section 31 and estimate the urine sheet weight W_{S} in accordance with the purchase history.

In this case, for example, the control section 21 can estimate a urine sheet product which the user is using, in accordance with the purchase history. Further, the control section 21 can access a server of a manufacturer of the urine sheet product thus estimated and, for example, obtain data on a weight of the urine sheet product from product information registered in the server.

The initial measured value W_{O}, the excreta tray weight W_{T}, the urine sheet weight W_{S}, and the state confirmation waiting time T thus set are stored in a storage section 27, and are obtained as necessary by the control section 21 depending on processes described below.

In the flow of the process illustrated in FIG. 6, processes in S22 through S28 are identical to the respective processes in S2 through S8 illustrated in FIG. 3, and therefore description of the processes in S22 through S28 will be omitted. In S26, in a case where a weight “w” measured by the weight scale 2 has changed (YES in S26), a disposition state determining section 25 starts to measure elapsed time t2 in cooperation with a timer section 24 (S29). Further, in a case where the weight “w” measured by the weight scale 2 has changed, the disposition state determining section 25 confirms a determination that the excreta tray 13 is disposed in the animal toilet 1.

After the disposition state determining section 25 has started to measure the elapsed time t2, the disposition state determining section 25 calculates a difference between (i) the weight “w” and (ii) a total value (W_{T}+W_{S}+W_{O}) of the excreta tray weight W_{T}, the urine sheet weight W_{S}, and the initial measured value W_{O}, and compares an absolute value of the difference (|w−(W_{T}+W_{S}+W_{O})|) with an acceptable value of error W_{M} (S30).

In a case where a value of |w−(W_{T}+W_{S}+W_{O})| is lower than the acceptable value of error W_{M} (YES in S30), it is considered that a change in weight in S26 indicates an increase in weight by a weight corresponding to (W_{T}+W_{S}). That is, in a case where |w−(W_{T}+W_{S}+W_{O})|<W_{M}, the disposition state determining section 25 determines that the excreta tray 13 is disposed in the animal toilet 1 and the urine sheet 14 is disposed on the excreta tray 13. In this case, the process carried out by the control section 21 returns to S22.

In a case where the value of |w−(W_{T}+W_{S}+W_{O})| is equal to or higher than the acceptable value of error W_{M} (NO in S30), the disposition state determining section 25 calculates a difference between (i) the weight “w” and (ii) a value (W_{T}+W_{O}) obtained by adding the initial measured value W_{O} to the excreta tray weight W_{T}, and compares an absolute value of the difference (|w−(W_{T}+W_{O}) with the acceptable value of error W_{M} (S31).

In a case where a value of |w−(W_{T}+W_{O})| is lower than the acceptable value of error W_{M} (YES in S31), the disposition state determining section 25 determines whether or not the elapsed time t2 has exceeded the state confirmation waiting time T (S32). In a case where the value of |w−(W_{T}+W_{O})| is equal to or higher than the acceptable value of error W_{M} (NO in S31), the process carried out by the control section 21 returns to S22.

In a case where the elapsed time t2 has exceeded the state confirmation waiting time T (YES in S32), the disposition state determining section 25 confirms a determination that the excreta tray 13 is disposed in the animal toilet 1 but the urine sheet 14 is not disposed on the excreta tray 13. That is, in a case where (i) the disposition state determining section 25 determines that the excreta tray 13 is disposed in the animal toilet 1 and (ii) a weight corresponding to the urine sheet 14, which is configured to be disposed on the excreta tray 13, is not obtained, the disposition state determining section 25 determines that the urine sheet 14 is not disposed on the excreta tray 13. In a case where the disposition state determining section 25 confirms such a determination, the process carried out by the control section 21 next proceeds to S34.

On the other hand, in a case where the elapsed time t2 is equal to or shorter than the state confirmation waiting time T (NO in S32), a weight obtaining section 23 determines whether or not the weight “w” measured by the weight scale 2 has changed (S33). In a case where the weight “w” measured by the weight scale 2 has changed (YES in S33), the process carried out by the control section 21 returns to S30. In a case where the weight “w” measured by the weight scale 2 has not changed (NO in S33), the process carried out by the control section 21 returns to S32.

In a case where the disposition state determining section 25 confirms a determination that the excreta tray 13 is disposed in the animal toilet 1 but the urine sheet 14 is not disposed on the excreta tray 13, the disposition state determining section 25 supplies such a determination result to the disposition state notifying section 26. The disposition state notifying section 26 causes a notification to be sent to the user, by a method similar to that in Embodiment 1. The notification is a notification indicating that the excreta tray 13 is disposed in the animal toilet 1 but the urine sheet 14 is not disposed on the excreta tray 13. That is, in a case where the disposition state determining section 25 determines that the urine sheet 14 is not disposed on the excreta tray 13, the disposition state notifying section 26 causes the notification to be sent to the user.

This makes it possible for the user to grasp a disposition state of the urine sheet 14 by receiving the notification timely, in a case where the urine sheet 14 is not disposed. This makes it unnecessary for the user to draw out the excreta tray 13 and visually check the excreta tray 13 on a regular basis so as to grasp the disposition state of the urine sheet 14 which is not seen from the outside.

(Summary of Determination of State)

The states which the control section 21 determines will be described below with reference to FIG. 7. In FIG. 7, a vertical axis indicates the weight “w” measured by the weight scale 2, and a horizontal axis indicates elapse of time. As illustrated in (a) of FIG. 7, in a case where the animal toilet 1 is brought into a state where the excreta tray 13 and the urine sheet 14 are disposed, from a state where the excreta tray 13 is not disposed (a state where no load is applied), the weight “w” increases. Specifically, the weight “w” increases by a weight of the excreta tray weight W_{T} and the urine sheet weight W_{S}. Thereafter, each time an animal excretes on the animal toilet 1, the weight “w” slightly increases.

In a case where the excreta tray 13 is detached from the animal toilet 1 for, for example, replacement of the urine sheet 14, the weight “w” returns to that in a state where no load is applied. In a case where the excreta tray 13 and the urine sheet 14 are disposed in the animal toilet 1 again before a given time (state confirmation waiting time T) elapses, the weight “w” increases again. Specifically, the weight “w” increases again by a weight of the excreta tray weight W_{T} and the urine sheet weight W_{S}. In a case where the animal toilet 1 is normally used, the animal toilet 1 is kept in a state where the excreta tray 13 and the urine sheet 14 are disposed in the animal toilet 1, except for a case where the urine sheet 14 is replaced with another, as above.

There is a case where the user forgets to dispose the excreta tray 13 in the animal toilet 1. As illustrated in (b) of FIG. 7, in a case where the weight “w” does not increase again for more than the given time (state confirmation waiting time T) after the excreta tray 13 is detached and the animal toilet 1 goes into a state where no load is applied, the control section 21 determines that the excreta tray 13 is not disposed in the animal toilet 1 (the user forgets to dispose the excreta tray 13).

Furthermore, a case is also considered where the user forgets to dispose the urine sheet 14 on the excreta tray 13 although the user has disposed the excreta tray 13 in the animal toilet 1. A case is considered where the excreta tray 13 is disposed again before the given time (state confirmation waiting time T) elapses after the excreta tray 13 is detached, as illustrated in (c) of FIG. 7. In this case, in a case where the urine sheet 14 is not disposed on the excreta tray 13, the weight “w” after the excreta tray 13 is disposed again is lighter by the urine sheet weight W_{S}.

That is, in a case where the weight “w” is lower than a value of W_{T}+W_{S} and is similar to a value of W_{T}, the control section 21 determines that the excreta tray 13 is disposed in the animal toilet 1 but the urine sheet 14 is not disposed on the excreta tray 13. In other words, the control section 21 determines that the user has disposed merely the excreta tray 13 without disposing the urine sheet 14.

In a case where the control section 21 determines that the user forgets to dispose the excreta tray 13 or that the user has disposed merely the excreta tray 13 without disposing the urine sheet 14, the control section 21 causes a notification to be sent to the user via a smartphone 33, a light emitting section included in the animal toilet 1, and/or the like.

A way in which the notification is sent to the user in a case where the user forgets to dispose the excreta tray 13 can be identical to or can be alternatively different from a way in which the notification is sent to the user in a case where the user has disposed merely the excreta tray 13 without disposing the urine sheet 14. In a case where the way in which the notification is sent in a case where the user forgets to dispose the excreta tray 13 is different from the way in which the notification is sent in a case where the user has disposed merely the excreta tray 13 without disposing the urine sheet 14, it is possible for the user, who has received the notification from the animal toilet 1, to grasp, merely from the way in which the notification is sent, which one of the excreta tray 13 and the urine sheet 14 is not disposed.

In a case where the way in which the notification is sent in a case where the user forgets to dispose the excreta tray 13 is different from the way in which the notification is sent in a case where the user has disposed merely the excreta tray 13 without disposing the urine sheet 14, the following can be employed. That is, for example, in a case where the user forgets to dispose the excreta tray 13, the control section 21 can cause (i) a message titled “Urgent” to be transmitted to the smartphone 33 and (ii) a way in which the light emitting section, included in the animal toilet 1, emits light to be changed, because it is highly important to notify the user.

On the other hand, in a case where the user has disposed merely the excreta tray 13 without disposing the urine sheet 14, the control section 21 can cause (i) a message titled “Important” to be transmitted to the smartphone 33 and (ii) the way in which the light emitting section, included in the animal toilet 1, emits light to be changed, because it is relatively low in importance to notify the user. A change in way in which the light emitting section emits light indicates, for example, that a state where green light is lighted up, which state indicates that the animal toilet 1 is turned on in a normal state, is changed to a state where red light is blinked.

Alternatively, the notification sent in a case where the user forgets to dispose the excreta tray 13 and the notification sent in a case where the user has disposed merely the excreta tray 13 without disposing the urine sheet 14 can be sent in the respective different ways with use of merely any one of the smartphone 33, the light emitting section included in the animal toilet 1, and the like. Note that the way in which the notification is sent is not limited to those ways, and any other way can be employed.

### Embodiment 3

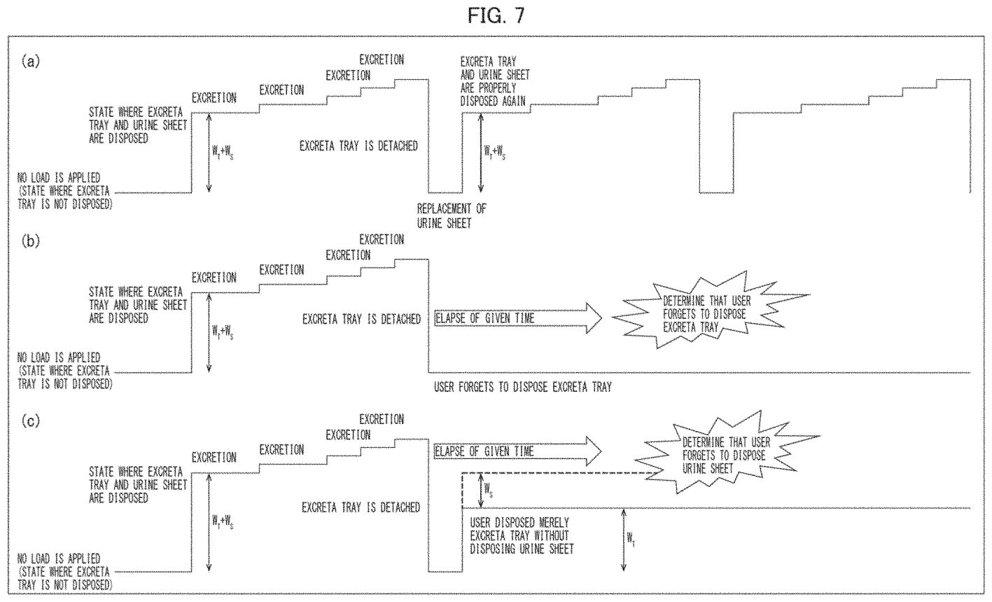

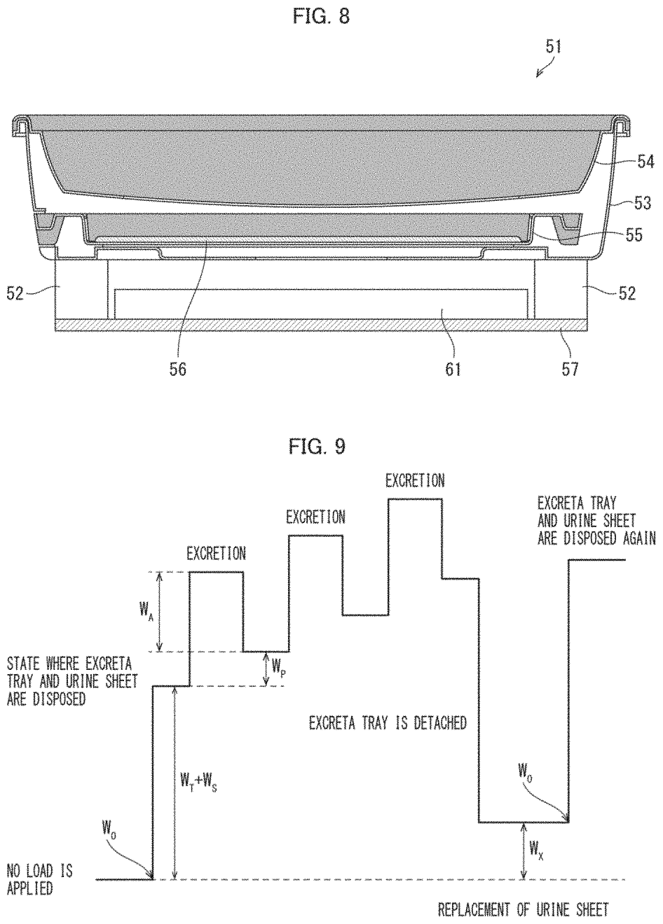

The following description will discuss Embodiment 3 of the present invention with reference to FIGS. 8 and 9. Note that, for convenience, a member having a function identical to that of a member described in Embodiment 1 or 2 will be given an identical reference numeral, and will not be described below. FIG. 8 is a cross-sectional view illustrating a cross-sectional configuration of an animal toilet 51 in accordance with Embodiment 3 of the present invention. FIG. 9 is a view illustrating a change in value measured by weight scales 52 included in the animal toilet 51. p A control section 61 in accordance with Embodiment 3 is different from the control section 21 in accordance with Embodiment 1 in that the control section 61 is embedded in the animal toilet 51 which does not have a configuration corresponding to the weight scale 2, which is included in the animal toilet 1 in accordance with Embodiment 1.

As illustrated in FIG. 8, the animal toilet 51 in accordance with Embodiment 3 includes the weight scales 52, a container body 53, an excretion stage 54, an excreta tray 55 (holding section), a supporting section 57, and the control section 61. An urine sheet 56 can be disposed on the excreta tray 55.

The weight scales 52 are supported by the supporting section 57, and measure a weight of the container body 53, the excretion stage 54, and the excreta tray 55. That is, a weight of the excreta tray 55 and a weight of the container body 53 and the excretion stage 54 onto which an animal steps are measured together by the weight scales 52. According to the above configuration, since it is possible to measure the weight of the excreta tray 55 and a weight of the animal by the weight scales 52, it is not necessary to provide, to the animal toilet 51, weight scales which independently measure respective different weights. It is therefore possible to provide the animal toilet 51 at a low cost. A value measured by the weight scales 52 is obtained by the control section 61.

As illustrated in FIG. 9, a weight “w” measured by the weight scales 52 includes an excreta tray weight W_{T}, a urine sheet weight W_{S}, a weight W_{A} of the animal, and the like. Note that the weight W_{A} is a weight other than an excreta weight W_{P} which is a weight of excreta of the animal. Therefore, in order to calculate a weight of a target object from the weight “w” measured by the weight scales 52, it is necessary to take into consideration a weight other than the weight of the target object. For example, in order to calculate the excreta weight W_{P}, it is only necessary to calculate a difference between (i) a weight before the animal steps onto the animal toilet 51 after the excreta tray 55 and the urine sheet 56 are disposed and (ii) a weight immediately after the animal steps down from the animal toilet 51 after excreting.

In a case where a disposition state of the excreta tray is determined in accordance with the weight “w” measured by the weight scales 52, it is necessary to take into consideration a weight W_{X} of an object placed on the excretion stage 54. Examples of the object include cat litter, feces, and an object (toy) which has been brought by the animal. Since the weight W_{X} is fluid, an initial measured value W_{O} is automatically set again each time the excreta tray 55 is detached and disposed again. By the control section 61 making a determination with reference to the initial measured value W_{O} thus set again, it is possible to accurately determine the disposition state of the excreta tray 55 in accordance with the weight “w” measured by the weight scales 52.

[Software Implementation Example]

The control device 22 can be realized by a logic circuit (hardware) provided on, for example, an integrated circuit (IC chip) or can be alternatively realized by software.

In the latter case, the control device 22 includes a computer which executes instructions of a program that is software realizing the foregoing functions. The computer includes, for example, at least one processor (control device) and at least one computer-readable storage medium that stores the program therein. The object of an aspect of the present invention is attained by, in the computer, the processor reading the program from the storage medium and executing the program. Examples of the processor include CPUs (Central Processing Units). Examples of the storage medium include “non-transitory tangible mediums” such as a tape, a disk, a card, a semiconductor memory, and a programmable logic circuit, as well as a ROM (Read Only Memory). The computer can further include a RAM (Random Access Memory) or the like in which the program is loaded. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

A control device in accordance with a first aspect of the present invention is a control device which controls an animal toilet, the control device including: a weight obtaining section which obtains, over time, a weight of a holding section that is configured to hold excreta of an animal and is configured to be disposed in the animal toilet so as to be located under a place onto which the animal steps; a disposition state determining section which determines that the holding section is not disposed in the animal toilet, in a case where the weight obtaining section has not obtained a weight corresponding to the holding section for a given time; and a disposition state notifying section which causes a notification to be sent to a user, in a case where the disposition state determining section determines that the holding section is not disposed in the animal toilet.

The control device in accordance with a second aspect of the present invention can be arranged such that, in the first aspect, in a case where (i) the disposition state determining section determines that the holding section is disposed in the animal toilet and (ii) the weight obtaining section does not obtain a weight corresponding to an excreta absorbing sheet, which is configured to be disposed on the holding section, the disposition state determining section determines that the excreta absorbing sheet is not disposed on the holding section; in a case where the disposition state determining section determines that the excreta absorbing sheet is not disposed on the holding section, the disposition state notifying section causes a notification to be sent to the user.

The control device in accordance with a third aspect of the present invention can be arranged such that, in the second aspect, a way in which the notification is sent to the user in the case where the disposition state determining section determines that the holding section is not disposed in the animal toilet is different from a way in which the notification is sent to the user in the case where the disposition state determining section determines that the excreta absorbing sheet is not disposed on the holding section.

The control device in accordance with a fourth aspect of the present invention can be arranged such that, in any one of the first through third aspects, the notification is sent to the animal in a way which the animal easily notices.

An animal toilet, in accordance with a fifth aspect of the present invention, including a control device can be an animal toilet including a control device in accordance with any one of the first through fourth aspects so as to notify a user of a disposition state of a holding section.

A method, in accordance with a sixth aspect of the present invention, of controlling an animal toilet is a method of controlling an animal toilet, the method including: a weight obtaining step of obtaining, over time, a weight of a holding section that is configured to hold excreta of an animal and is configured to be disposed in the animal toilet so as to be located under a place onto which the animal steps; a disposition state determining step of determining that the holding section is not disposed in the animal toilet, in a case where a weight corresponding to the holding section has not been obtained for a given time in the weight obtaining step; and a disposition state notifying step of causing a notification to be sent to a user, in a case where it is determined, in the disposition state determining step, that the holding section is not disposed in the animal toilet.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 50, 51 Animal toilet
2, 52 Weight scale
3 Body weight scale
11, 53 Container body
12, 54 Excretion stage
12a Mesh part
13, 55 Excreta tray
14, 56 Urine sheet
15, 57 Supporting section
21, 41, 61 Control section
22 Control device
23 Weight obtaining section
24 Timer section
25 Disposition state determining section
26 Disposition state notifying section
27 Storage section
28 Power source section
31, 49 Communication section
32 Server group
33 Smartphone
34 LED
35 Speaker
40 Server

1. A control device which controls an animal toilet, the control device comprising:
a weight obtaining section which obtains, over time, a weight of a holding section that is configured to hold excreta of an animal and is configured to be disposed in the animal toilet so as to be located under a place onto which the animal steps;
a disposition state determining section which determines that the holding section is not disposed in the animal toilet, in a case where the weight obtaining section has not obtained a weight corresponding to the holding section for a given time; and
a disposition state notifying section which causes a notification to be sent to a user, in a case where the disposition state determining section determines that the holding section is not disposed in the animal toilet.

2. The control device as set forth in claim 1, wherein:
in a case where (i) the disposition state determining section determines that the holding section is disposed in the animal toilet and (ii) the weight obtaining section does not obtain a weight corresponding to an excreta absorbing sheet, which is configured to be disposed on the holding section, the disposition state determining section determines that the excreta absorbing sheet is not disposed on the holding section;
in a case where the disposition state determining section determines that the excreta absorbing sheet is not disposed on the holding section, the disposition state notifying section causes a notification to be sent to the user.

3. The control device as set forth in claim 2, wherein a way in which the notification is sent to the user in the case where the disposition state determining section determines that the holding section is not disposed in the animal toilet is different from a way in which the notification is sent to the user in the case where the disposition state determining section determines that the excreta absorbing sheet is not disposed on the holding section.

4. The control device as set forth in claim 1, wherein the notification is sent to the animal in a way which the animal easily notices.

5. An animal toilet comprising a control device recited in claim 1 so as to notify a user of a disposition state of a holding section.

6. A method of controlling an animal toilet, the method comprising:
a weight obtaining step of obtaining, over time, a weight of a holding section that is configured to hold excreta of an animal and is configured to be disposed in the animal toilet so as to be located under a place onto which the animal steps;
a disposition state determining step of determining that the holding section is not disposed in the animal toilet, in a case where a weight corresponding to the holding section has not been obtained for a given time in the weight obtaining step; and
a disposition state notifying step of causing a notification to be sent to a user, in a case where it is determined, in the disposition state determining step, that the holding section is not disposed in the animal toilet.
